(19) United States
(12) Patent Application Publication
(10) Pub. No.: US 2024/0394662 A1
(43) Pub. Date: Nov. 28, 2024

(54) CANDIDATE FRAUD DETECTION

(71) Applicant: Dell Products L.P., Round Rock, TX (US)

(72) Inventors: Ajay Maikhuri, Bangalore (IN); Dhilip Kumar, Bangalore (IN)

(73) Assignee: Dell Products L.P., Round Rock, TX (US)

(21) Appl. No.: 18/324,320

(22) Filed: May 26, 2023

(51) Int. Cl. G06Q 10/1053

(52) U.S. Cl. CPC G06Q 10/1053

(57) ABSTRACT

An example methodology includes, by a computing device, receiving a recording of a virtual interview, the recording including an audio of the virtual interview and a video of the virtual interview, retrieving a profile image of a candidate, and determining an appearance of an interviewee in the video of the virtual interview. The method also includes, responsive to a determination that the appearance of the interviewee and profile image do not match, including, by the computing device, an indication that the candidate did not participate in the virtual interview in an assessment of authenticity of the candidate. The method further includes sending, by the computing device, a report of the assessment of the authenticity of the candidate to another computing device.

### BACKGROUND

Recruiting the right candidates for open job positions is critically important for organizations. Hiring the right candidates for open job positions improves the performance of the organization as well as saving the organization time and money it would otherwise have to spend to find the right candidates. In contrast, hiring the wrong candidate not only impacts the productivity of the organization but can also create negative consequences for the organization.

With the emergence of video conferencing and other online communication technologies, organizations are increasingly conducting virtual (or online) interviews to recruit the right candidates. The use of virtual interviews streamlines an organization's recruiting and hiring process. Virtual interviews save time and cost and provide greater flexibility for both the interviewer and the interviewee. In addition, virtual interviews can be videotaped for training purposes or for reviewing with hiring management, if necessary, for the hiring decision-making.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving a recording of a virtual interview, the recording including an audio of the virtual interview and a video of the virtual interview, retrieving a profile image of a candidate, and determining an appearance of an interviewee in the video of the virtual interview. The method also includes, responsive to a determination that the appearance of the interviewee and profile image do not match, including, by the computing device, an indication that the candidate did not participate in the virtual interview in an assessment of authenticity of the candidate. The method further includes sending, by the computing device, a report of the assessment of the authenticity of the candidate to another computing device.

In some embodiments, the method also includes, by the computing device, storing information about the appearance of the interviewee in a knowledge repository.

In some embodiments, the method also includes, by the computing device, determining a speech pattern of the interviewee from the audio of the virtual interview and storing information about the speech pattern of the interviewee in a knowledge repository.

In some embodiments, the method also includes, by the computing device, determining a body language of the interviewee from the video of the virtual interview and storing information about the body language of the interviewee in a knowledge repository.

In some embodiments, the method also includes, by the computing device, retrieving information about speech pattern and body language of the interviewee from prior interviews, determining a speech pattern of the interviewee from the audio of the virtual interview, and determining a body language of the interviewee from the video of the virtual interview. The method further includes, by the computing device, determining whether a same candidate appears in successive interviews based on a comparison of the information about the speech pattern and the body language of the interviewee from the prior interviews and the information about the speech pattern and the body language of the interviewee from the audio and the video of the virtual interview and, responsive to a determination that the same candidate does not appear in the successive interviews, including an indication that the same candidate does not appear in the successive interviews in the assessment of authenticity of the candidate.

In some embodiments, the method also includes, by the computing device, determining whether the interviewee is participating in the virtual interview independently and. responsive to a determination that the interviewee is not participating in the virtual interview independently, including an indication that the candidate did not participate in the virtual interview independently in the assessment of authenticity of the candidate.

In some embodiments, the determining whether the interviewee is participating in the virtual interview independently is based on a presence of one or more external resource indicators which indicate possible use of external resources.

In some embodiments, the presence of one or more external resource indicators is based on an analysis of the audio of the virtual interview.

In some embodiments, the presence of one or more external resource indicators is based on an analysis of the video of the virtual interview.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including receiving a recording of a virtual interview, the recording including an audio of the virtual interview and a video of the virtual interview, retrieving a profile image of a candidate, and determining an appearance of an interviewee in the video of the virtual interview. The process also includes, responsive to a determination that the appearance of the interviewee and profile image do not match, including an indication that the candidate did not participate in the virtual interview in an assessment of authenticity of the candidate. The process further includes sending a report of the assessment of the authenticity of the candidate to a computing device.

According to another illustrative embodiment provided to illustrate the broader concepts described herein, a non-transitory machine-readable medium encodes instructions that when executed by one or more processors cause a process to be carried out, the process including receiving a recording of a virtual interview, the recording including an audio of the virtual interview and a video of the virtual interview, retrieving a profile image of a candidate, and determining an appearance of an interviewee in the video of the virtual interview. The process also includes, responsive to a determination that the appearance of the interviewee and profile image do not match, including an indication that the candidate did not participate in the virtual interview in an assessment of authenticity of the candidate. The process further includes sending a report of the assessment of the authenticity of the candidate to a computing device.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a diagram of an illustrative network environment in which candidate fraud detection may be implemented, in accordance with an embodiment of the present disclosure.

FIG. 5 is a block diagram of an illustrative system for candidate fraud detection, in accordance with an embodiment of the present disclosure.

FIG. 6 is a flow diagram of an example process for determining whether a candidate who applied for the position participates in a virtual interview, in accordance with an embodiment of the present disclosure.

FIG. 7 is a flow diagram of an example process for determining whether an interviewee is participating in a virtual interview independently, in accordance with an embodiment of the present disclosure.

FIG. 8 is a flow diagram of an example process for determining whether the same candidate is interviewing in successive interviews, in accordance with an embodiment of the present disclosure.

### DETAILED DESCRIPTION

Virtual interviews do have some disadvantages. One increasing problem is the alarming rise in candidate fraud during virtual interviews. Candidate fraud occurs when a candidate misrepresents themselves to the potential employer, e.g., the interviewer. For example, as many organizations conduct several rounds of interviews, the a candidate may use proxies for successive interviews. As another example, a candidate may lip sync while another person responds to the interviewer. As still another example, the candidate may refer to externals resources when responding to the interviewer. These and other issues with virtual interviews may hinder organizations that rely on virtual interviews from hiring the right employees.

Certain embodiments of the concepts, techniques, and structures disclosed herein are directed to an artificial intelligence (AI)/machine learning (ML)-powered framework for candidate fraud detection in virtual interviews. The candidate fraud detection can be achieved by recording the virtual interviews with the candidates and using AI/ML to analyze the interactions of the candidates in the recordings for potential fraud. According to some embodiments, candidate fraud may be based on a determination of whether a candidate who applied for a position participated in the virtual interview. According to some embodiments, candidate fraud may be based on a determination of whether an interviewee is participating in an interview independently. According to some embodiments, candidate fraud may be based on a determination of whether the same candidate is interviewing in the successive interviews. Numerous variations and configurations will be apparent in light of this disclosure.

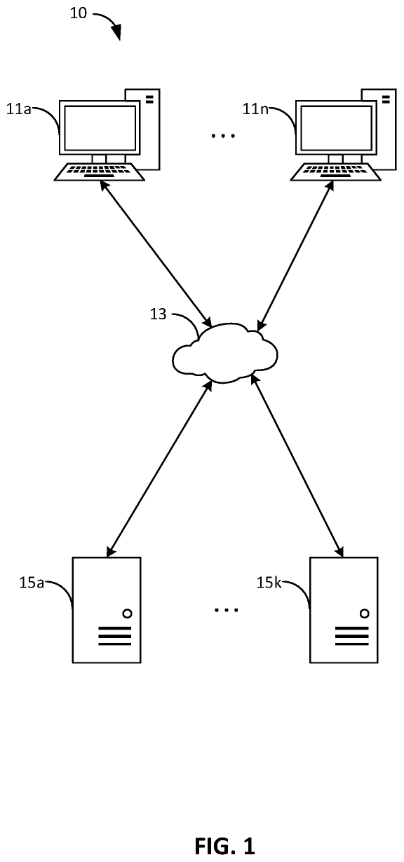

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

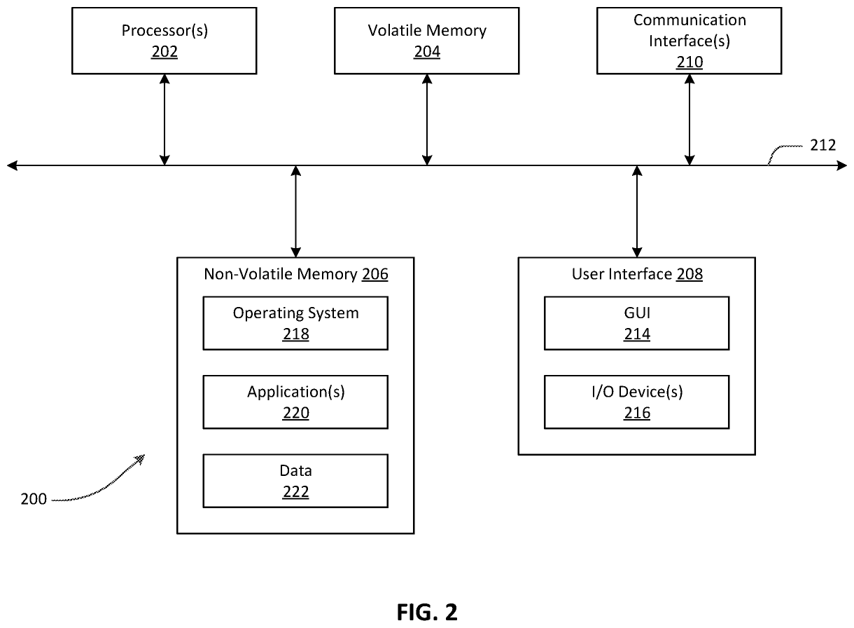

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

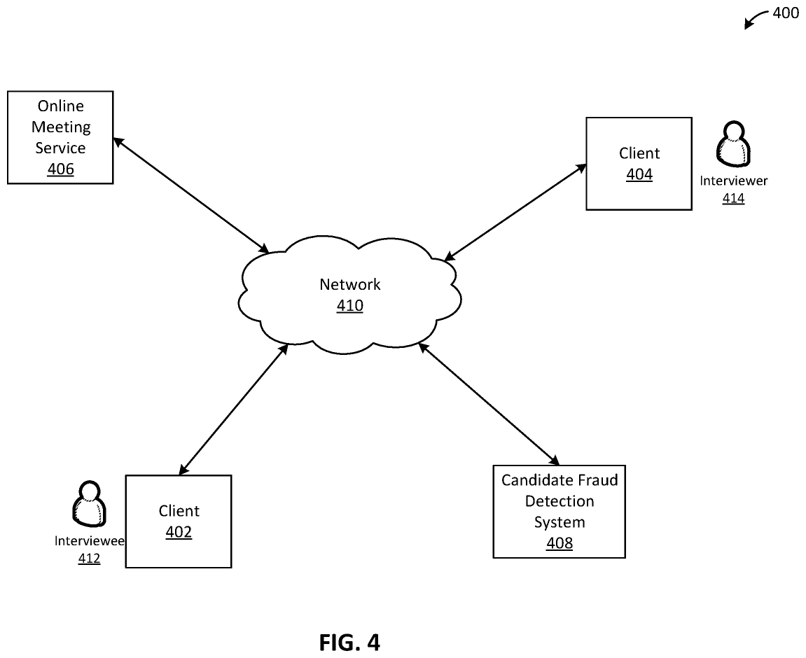

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

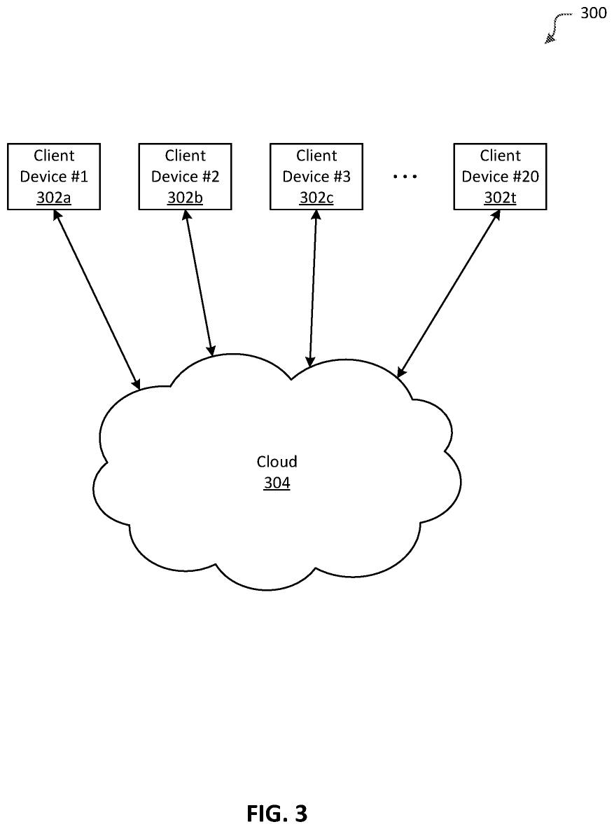

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including. e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a diagram of an illustrative network environment 400 in which candidate fraud detection may be implemented, in accordance with an embodiment of the present disclosure. As shown, illustrative network environment 400 includes clients 402, 404, an online meeting service (or “meeting service”) 406, and a candidate fraud detection system 408. Clients 402, 404, meeting service 406, and candidate fraud detection system 408 may be communicably coupled to one another via one or more networks 410 (e.g., via the Internet).

Clients 402, 404 may be used by or otherwise associated with users 412, 414, respectively. Users 412, 414 may correspond to participants in an online meeting hosted by meeting service 406. Clients 402, 404 can include, for example, desktop computing devices, laptop computing devices, tablet computing devices, and/or mobile computing devices. Clients 402, 404 can be configured to run one or more applications, such as desktop applications, mobile applications, and SaaS applications. Among various other types of applications, clients 402, 404 can run an online meeting application (sometimes referred to herein more simply as a “meeting application”) that provides audio and video conferencing among other features. For example, clients 402, 404 can run TEAMS, SKYPE, ZOOM, or another meeting application. The meeting application running on clients 402, 404 can communicate with meeting service 406. In some embodiments, a client 402, 404 may be the same or substantially similar to client machine 11 of FIG. 1, computing device 200 of FIG. 2, and/or client device 302 of FIG. 3.

Meeting service 406 may provide collaboration and communication functionality to enable virtual interviews to occur between interview participants at various locations. For example, meeting service 406 may correspond to an online meeting service such as TEAMS, SKYPE, ZOOM, etc.

In the example of FIG. 4, users 412, 414 may use clients 402, 404, respectively, to participate in a virtual (or online) interview (sometimes referred to herein more simply and an “interview”). For example, user 412 may be an interviewee and user 414 may be an interviewer in the interview. Interviewer 414 may be a member of a human resource department or a hiring manager or another associate within or associated with an organization. In some cases, interviewer 414 may be composed of more than one interviewer (e.g., an interview panel). During the interview, the meeting application on client 402 may provide (e.g., generate) a video stream captured by a camera connected to or otherwise associated with client 402. The video stream may show (e.g., include an appearance of) interviewee 412 along with other objects that happen to be within the camera's field of view. The meeting application on client 402 may also provide an audio stream of the sound (e.g., speech) detected by a microphone connected to or otherwise associated with client 402. The audio stream may include the audio from (i.e., speech or sounds made by) interviewee 412. Client 402 may transmit or otherwise send the audio and video streams to meeting service 406 via network 410 and, in turn, meeting service 406 may transmit the audio and video streams to client 404. Similarly, a meeting application on client 404 may provide a video stream and an audio stream associated with interviewer 414 and transmit the audio and video streams to meeting service 406 via network 410 and, in turn, meeting service 406 may transmit the audio and video streams to client 402.

Subsequent to the conclusion of the virtual interview, candidate fraud detection system 408 may receive a recording of the interview (e.g., the audio and video of the interview) for analysis of potential candidate fraud. For example, candidate fraud detection system 408 may receive the recording of the virtual interview from client 404. Upon receipt thereof, candidate fraud detection system 408 may analyze the video provided by the interviewee's client to determine whether interviewee 412 appearing in the video matches an image of interviewee 412. That is, candidate fraud detection system 408 may analyze the images of the video stream provided by the interviewee's client to determine whether the appearance of the interviewee participating in the interview (e.g., appearance of interviewee 412 in the images) is the same as the appearance of a candidate who applied for the position with the organization.

In some embodiments, candidate fraud detection system 408 may store or otherwise have access to data representative of the appearance of along with various other information about the candidate who applied for the position. The data representative of the candidate's appearance (i.e., appearance of the candidate) may include a digital image of the candidate and, in some cases, a digital image that shows the face of the candidate. Such a digital image may be referred to as a “profile image.” In some embodiments, candidate fraud detection system 408 can retrieve the profile image of the candidate from a repository (e.g., an image repository) maintained by the organization to store images and other image data of candidates who applied for positions with the organization. Candidate fraud detection system 408 can use the profile image of the candidate who applied for the position to determine whether the candidate attended (e.g., participated in) the interview based on a comparison of the appearance of interviewee 412 in the video and the profile image of the candidate. If the appearance of interviewee 412 in the video and the profile image of the candidate does not match (e.g., are not the same), candidate fraud detection system 408 can determine that interviewee 412 and the candidate who applied for the position are different (i.e., interviewee 412 is not the candidate who applied for the position). In some embodiments, candidate fraud detection system 408 may include an indication to this affect in a report of an assessment of the authenticity of the candidate.

In some embodiments, candidate fraud detection system 408 may analyze the video of the interview to determine the body language including facial expressions and gestures of interviewee 412. In some implementations, candidate fraud detection system 408 may utilize image analysis (also known as “computer vision”) techniques to determine the body language including facial expressions and gestures of interviewee 412. This may be done, for example, for use in determining whether the same candidate appears in successive interviews. That is, candidate fraud detection system 408 may determine the body language, facial expressions, and gestures of interviewee 412 appearing in the images from the interview and compare with the body language, facial expressions, and gestures of interviewee 412 from images of previous interviews to determine whether the same candidate is appearing in the interviews. Candidate fraud detection system 408 can store information about the body language including facial expressions and gestures of interviewee 412 within a repository, such as a knowledge repository. maintained by the organization.

In some embodiments, candidate fraud detection system 408 may analyze the audio of the interview to determine the speech pattern of interviewee 412. In some implementations, candidate fraud detection system 408 may utilize speech analysis techniques including speech recognition to determine the speech pattern (e.g., tone, modulation, pitch, etc.) of interviewee 412. This may be done, for example, for use in determining whether the same candidate is interviewing in successive interviews. That is, candidate fraud detection system 408 may determine the speech pattern of interviewee 412 appearing in the images from interview and compare with the speech pattern of the interviewee from previous interviews to determine whether the same candidate is interviewing in the successive interviews. Candidate fraud detection system 408 can store information about the speech pattern of interviewee 412 within a repository, such as a knowledge repository, maintained by the organization. If candidate fraud detection system 408 determines that interviewee 412 is not the same as the candidate in any of the preceding interviews, candidate fraud detection system 408 may include an indication that the same candidate is not interviewing in the successive interviews in a report of an assessment of the authenticity of the candidate.

In some embodiments, candidate fraud detection system 408 may analyze the audio and video of the interview to determine whether interviewee 412 is participating in the interview independently. In some embodiments, candidate fraud detection system 408 may utilize natural language processing (NLP), image analysis, and speech analysis techniques to detect the presence of indicators which indicate possible of use of external resources by interviewee 412. Such indicators of the possible use of external resources may be referred to as “external resource indicators.” Non-limiting examples of external resource indicators include extreme anxiety (e.g., profuse sweating, coughing, or throat clearing by interviewee 412), lip synching, mouse exits, mismatches between eye and cursor movements, interviewee 412 turning away from the camera (e.g., eye movements diverting away from the camera), delays in responses to questions, and echoes from speakers. This may be done, for example, for use in determining whether interviewee 412 is referring to external resources during the interview. If any external resource indicators are detected, candidate fraud detection system 408 may include an indication of the possible use of external resources by interviewee 412 during the interview in a report of an assessment of the authenticity of the candidate.

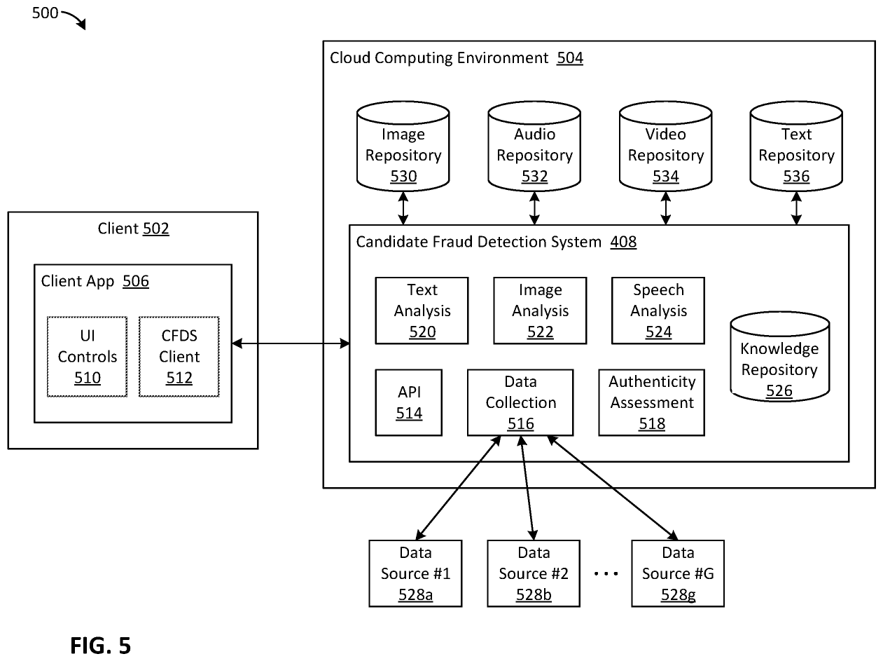

FIG. 5 is a block diagram of an illustrative system 500 for candidate fraud detection, in accordance with an embodiment of the present disclosure. Illustrative system 500 includes a client application 506 operable to run on a client 502 and configured to communicate with a cloud computing environment 504 via one or more computer networks. Client 502 and cloud computing environment 504 of FIG. 4 can be the same as or similar to client 11 of FIG. 1 and cloud computing environment 300 of FIG. 3, respectively.

As shown in FIG. 5, candidate fraud detection system 408 can be provided within cloud computing environment 504. For example, an organization such as a company, an enterprise, or other entity that hires employees, for instance, may implement and use candidate fraud detection system 408 to determine the occurrence of candidate fraud during interviews. FIG. 5 shows a single client application 506 communicably coupled to candidate fraud detection system 408. However, embodiments of candidate fraud detection system 408 can be used to service many client applications (e.g., client applications 506) running on client devices (e.g., clients 402) associated with one or more organizations and/or users. Client application 506 and/or candidate fraud detection system 408 may be implemented as computer instructions executable to perform the corresponding functions disclosed herein. Client application 506 and candidate fraud detection system 408 can be logically and/or physically organized into one or more components. In the example of FIG. 5, client application 506 includes UI controls 510 and a candidate fraud detection system (CFDS) client 512. Also, in this example, candidate fraud detection system 408 includes an application programming interface (API) module 514, a data collection module 516, an authenticity assessment module 518, a text analysis module 520, an image analysis module 522, a speech analysis module 524, and a knowledge repository 526.

The client-side client application 506 can communicate with the cloud-side candidate fraud detection system 408 using an API. For example, client application 506 can utilize CFDS client 512 to send requests (or “messages”) to candidate fraud detection system 408 wherein the requests are received and processed by API module 514 or one or more other components of candidate fraud detection system 408. Likewise, candidate fraud detection system 408 can utilize API module 414 to send responses/messages to client application 506 wherein the responses/messages are received and processed by CFDS client 512 or one or more other components of client application 506.

Client application 506 can include various UI controls 510 that enable a user (e.g., a user of client 502), such as a hiring manager or another associate within or associated with an organization, to access and interact with candidate fraud detection system 408. For example, UI controls 510 can include UI elements/controls, such as input fields and text fields, with which the user can specify details about a candidate who is interviewing or has interviewed with the organization (e.g., information about an applicant for a job position). UI controls 510 may also include an input field the user can use to specify a recording of a virtual interview that is to be analyzed, such as a link to the recording of the interview. In some implementations, some or all the UI elements/controls can be included in or otherwise provided via one or more electronic forms configured to provide a series of fields where data is collected, for example. UI controls 510 can include UI elements/controls that the user can click/tap to request an assessment of the authenticity of the candidate in the interview. In response to the user's input, client application 506 can send a message to candidate fraud detection system 408 requesting an assessment of the authenticity of the candidate in the interview.

Client application 506 can also include UI controls 510 that enable a user to view information and details of the assessment of the authenticity of the candidate. For example, in some embodiments, responsive to sending a request for an assessment of the authenticity of a candidate in the interview, client application 506 may receive a response from candidate fraud detection system 408 which includes a report detailing an assessment of the authenticity of the candidate. UI controls 510 can include a button or other type of control/element for displaying an assessment of the authenticity of the candidate during the interview, for example, on a display connected to or otherwise associated with client 502.

In the embodiment of FIG. 5, client application 506 is shown as a stand-alone client application. In other embodiments, client application 506 may be implemented as a plug-in or extension to another application on client 502, such as, for example, a web browser or an enterprise client application. In such embodiments, UI controls 510 may be accessed within the other application in which client application 506 is implemented (e.g., accessed within the web browser or the enterprise client application).

Referring to the cloud-side candidate fraud detection system 408, data collection module 516 is operable to collect or otherwise retrieve information and data about candidates interviewing for positions with the organization from one or more data sources 528a-528g (528 generally). In some embodiments, data sources 528 can include various online forums including social media platforms (e.g., social media sites), such as GLASSDOOR and LINKEDIN, which contain user resumes and user job profiles. In one implementation, data collection module 516 can collect (or “scrape”) posts and other content shared on the various online forums for resumes and job profiles of candidates interviewing for positions with the organization. Data collection module 516 may store the collected resumes and job profiles (e.g., images of the resumes and job profiles of the candidates) within an image repository 530.

Data sources 528 can also include the meeting services (e.g., online meeting service 406 of FIG. 4) utilized by the organization to conduct the virtual interviews. The meeting services may provide recordings of the organization's virtual interviews which can be downloaded. In one implementation, data collection module 516 can download the recordings of the virtual interviews from the meeting services used to conduct the virtual interviews. Data collection module 516 may store the audio from the downloaded recordings (e.g., the audio component of the virtual interview recordings) within an audio repository 532 and the video from the downloaded recordings (e.g., the video component of the virtual interview recordings) within a video repository 534.

Data sources 528 can also include one or more email services and one or more messaging applications utilized by the organization. In one implementation, data collection module 516 can retrieve the email exchanges between the individual candidates and the organization from the email services. Data collection module 516 can similarly retrieve the chat conversations between the individual candidates and the organization from the messaging applications. Data collection module 516 may utilize APIs (e.g., a representational state transfer (REST)-based API) provided by the emails services and messaging applications to query/retrieve information therefrom. Data collection module 516 may store the retrieved emails and chat conversations within a text repository 536.

In some embodiments, repositories 530, 532, 534, 536 may correspond to database management systems, such as relational database management systems. In some embodiments, repositories 530, 532, 534, 536 may correspond to one or more storage services within cloud computing environment 504.

In some embodiments, the information and data collected/retrieved from data sources 528 may be analyzed to determine the knowledge and experience of the individual candidates. For example, for a given candidate, chat or email interaction may demonstrate the candidate's business domain and technology expertise. Similarly, resume or job profile from the online forums may indicate the candidate's experience in diverse business domains and technologies and audio and video from the recordings of the virtual interviews may illuminate the knowledge and experience of the candidates in greater detail. The relationship of the information and data from the various data sources 528 can assist in determining the consistency of a candidate's knowledge and expertise across multiple rounds of interviews. To this end, according to one embodiment, upon collecting/retrieving the resumes, job profiles, emails, or chat conversations, data collection module 516 may leverage text analysis module 520 to determine the intent and sentiment conveyed by the resumes, job profiles, emails, and chat conversations.

Authenticity assessment module 518 is operable to analyze recordings of virtual interviews and provide an assessment of the authenticity of the candidates in the virtual interviews. In some embodiments, authenticity assessment module 518 may analyze a recording of a virtual interview in response to a request for an assessment of the authenticity of a candidate in the interview. In brief, the authenticity of a candidate may be based on the consistency of the candidate's image (e.g., appearance), body language, speech pattern, and different activities performed by the candidate during the round of interviews.

In some embodiments, authenticity assessment module 518 may determine the authenticity of a candidate based on whether the candidate and the interviewee in the interview are the same. In more detail, authenticity assessment module 518 can analyze the video from the interviewee's client (e.g., the images of the video stream provided by the interviewee's client) to determine the appearance of the interviewee participating in the interview. In some embodiments, authenticity assessment module 518 may leverage image analysis module 522 to determine the appearance of the interviewee in the images of the video stream provided by the interviewee's client. Authenticity assessment module 518 can then compare the appearance of the interviewee with a profile image of the candidate to determine whether the candidate and the interviewee are the same. In some embodiments, authenticity assessment module 518 may also consider the emotions expressed by the interviewee in the images from the interview and the emotions expressed in the profile image of the candidate to determine whether the candidate and the interviewee are the same. In any case, authenticity assessment module 518 may generate a report of the assessment of the authenticity of the candidate which includes an indication of whether the candidate and the interviewee in the interview are the same. Authenticity assessment module 518 may then include the generated report in a response to the request for an assessment of the authenticity of the candidate in the interview.

In some embodiments, authenticity assessment module 518 may determine the authenticity of a candidate based on whether the interviewee is participating in the interview independently. In more detail, authenticity assessment module 518 can analyze the audio and video of the interview (e.g., the images from the interview) to detect the presence of external resource indicators which indicate possible use of external resources by the interviewee during the interview. In some embodiments, authenticity assessment module 518 may leverage image analysis module 522 and/or speech analysis module 524 to determine the body language of the interviewee and activities performed by the interviewee from the audio and the images from the interview. Authenticity assessment module 518 can then analyze the body language and the activities performed by the interviewee during the interview to determine whether the interviewee participated in the interview independently. For example, according to some embodiments, the analysis may be for presence of extreme anxiety, including profuse sweating, coughing, or throat clearing, by the interviewee during the interview. Display of such anxiety by the interviewee may be a sign that the interviewee is nervous and may be lying. As another example, the analysis may be for presence of lip syncing by the interviewee. For example, movement of the interviewee's lips may not be in time with the speech as may be the case where someone other than the interviewee is speaking (e.g., answering questions on behalf of the interviewee). As still another example, the analysis may be for presence of mouse exits which may be the case when the interviewee is opening new tabs or conducting online searches to answer questions during the interview. As another example, the analysis may be for the presence of mismatches between the movements of the interviewee's eyes and the movements of the cursor. The eye and cursor movements not being in sync may also be an indication that the interviewee is referencing other materials when answering questions. As still another example, the analysis may be of the interviewee's eye, hand, shoulder, and cursor movements as the interviewee writes code or performs other tasks requested during the interview. As a further example, the analysis may be for presence of the interviewee turning away from the camera, delays in responses to questions, or echoing from the speakers, which may be an indication of the use of an external resource by the interviewee during the interview. In some embodiments, the interviewee's responses to questions (e.g., speech and written text) may be analyzed using NLP techniques to determine the intent/sentiment is reflective of the intent and sentiment conveyed by the interviewee's resume, job profile, emails, and chat conversations to determine whether the interviewee relied on an external resource during the interview. Authenticity assessment module 518 may generate a report of the assessment of the authenticity of the candidate which includes an indication of whether the interviewee participated in the interview independently. Authenticity assessment module 518 may then include the generated report in a response to the request for an assessment of the authenticity of the candidate in the interview.

In some embodiments, authenticity assessment module 518 may determine the authenticity of a candidate based on whether the same candidate appears in successive interviews. In more detail, authenticity assessment module 518 can analyze the video of the interview (e.g., the images from the interview) to determine the body language including facial expressions and gestures of the interviewee participating in the interview. In some embodiments, authenticity assessment module 518 may leverage image analysis module 522 to determine the body language of the interviewee from the images from the interview. Authenticity assessment module 518 can then compare the body language of the interviewee in the interview with the body language, facial expressions, and gestures of interviewees from images of previous interviews to determine whether the same candidate is appearing in the successive interviews. In at least one embodiment, authenticity assessment module 518 can also analyze the audio of the interview to determine the speech pattern (e.g., emotions and stress in the voice) of the interviewee participating in the interview. In some embodiments, authenticity assessment module 518 may leverage speech analysis module 524 to determine the speech pattern of the interviewee from the audio of the interview. Authenticity assessment module 518 can then compare the speech pattern of the interviewee in the interview with the speech patterns of interviewees from previous interviews to determine whether the same candidate is appearing in the successive interviews.

In at least one embodiment, authenticity assessment module 518 can also analyze the images from the interview to determine the appearance of the interviewee participating in the interview. In some embodiments, authenticity assessment module 518 may leverage image analysis module 522 to determine the appearance of the interviewee in the images from the interview. Authenticity assessment module 518 can then compare the appearance of the interviewee with the images of interviewees from previous interviews to determine whether the same candidate is appearing in the successive interviews. Authenticity assessment module 518 may generate a report of the assessment of the authenticity of the candidate which includes an indication of whether the same candidate appears in successive interviews. Authenticity assessment module 518 may then include the generated report in a response to the request for an assessment of the authenticity of the candidate in the interview.

Still referring to candidate fraud detection system 408, text analysis module 520 is operable to analyze textual content from communications associated with the candidates, such as audio and/or written text from virtual interviews, resumes, job profiles, emails, and chat conversations, to understand the sentiment and intent conveyed by such communications. It is appreciated that the sentiment and intent conveyed in text data (e.g., written communication or message) may be important to understanding the context of the text data and making the correct hiring decision. Text analysis module 520 can analyze the text data (i.e., textual content) included in the communications associated with the candidates to determine a sentiment, such as worry, happy, neutral, or sad, among others, expressed in the text data. In some cases, this can be accomplished by analyzing the text data to identify the positive or negative intensity of words, phrases, and symbols within the text, punctuation, emojis, less expressive text, and delayed expressive text. Text analysis module 520 can analyze the text data included in the communications associated with the candidates to determine the intent conveyed by the text data, which may be indicative of the purpose or objective of the communications. Text analysis module 520 can store information about the analysis of the textual content from communications associated with the candidates within knowledge repository 526, where it can subsequently be retrieved and used. In some embodiments, knowledge repository 526 may correspond to a storage service within the computing environment of candidate fraud detection system 408.

In some embodiments, text analysis module 520 may utilize ML and Natural Language Understanding (NLU) to analyze the text data to understand the sentiment conveyed by the text data. For example, in some implementations, text analysis module 520 can utilize a first Bi-LSTM model to predict a sentiment conveyed by the text data. The first Bi-LSTM model may be trained and tested using machine learning techniques with a modeling dataset generated from a corpus of sentiment data. Once trained, the trained first Bi-LSTM model of text analysis module 520 can, in response to input of text data, predict a sentiment conveyed by the text data More particularly, the trained first Bi-LSTM model can repeatedly predict the sentiment as each token in a piece of text ingested, and output a prediction (i.e., a sentiment prediction) after seeing all the tokens in the piece of text.

In some embodiments, text analysis module 520 can utilize ML and NLU to analyze the text data to understand the intent conveyed by the text data. For example, in some implementations, text analysis module 520 can utilize a second Bi-LSTM model to predict an intent conveyed by the text data. The second Bi-LSTM model may be trained and tested using machine learning techniques with a modeling dataset generated from a corpus of intent data. Once trained, the trained second Bi-LSTM model of text analysis module 520 can, in response to input of text data, predict an intent conveyed by the text data More particularly, the trained second Bi-LSTM model can repeatedly predict the intent as each token in a piece of text ingested, and output a prediction (i.e., an intent prediction) after seeing all the tokens in the piece of text.

Image analysis module 522 is operable to determine the body language including the facial expressions and gestures of an interviewee appearing in the images from an interview. In some embodiments, image analysis module 522 can utilize image analysis techniques to recognize the facial expressions and gestures appearing in an image or a sequence of images. In more detail, image analysis module 522 may utilize a convolutional neural network (CNN) to identify and categorize the emotional expressions (e.g., neutral, sadness, surprise, happiness, fear, anger, disgust, contempt, smile, squint, and scream) depicted on the faces appearing in the images. The CNN model may be trained and tested using one or more facial expression datasets such as FER2013, Extended CohnKanade (CK+), Japanese Female Facial Expressions (JAFFE), and Toronto Faces Dataset (TFD), among others. In at least one embodiment, the CNN model may be trained/tested using a combination of facial expression datasets to improve the accuracy of the model. Once trained, the trained CNN model can, in response to input of an image from the interview, predict the emotional expression depicted on the face(s) appearing in the image. Note that the interviewee appears in the images of the video stream provided by the interviewee's client. Thus, by inputting an image of the video stream provided by the interviewee's client, the trained CNN model can predict the facial expression (i.e., emotional expression depicted on the face) of the interviewee appearing in the image. Image analysis module 522 can store information about the body language including the facial expressions and gestures of the interviewee within knowledge repository 526, where it can subsequently be retrieved and used.

In some embodiments, image analysis module 522 may utilize a decision tree-based algorithm, such as a random forest for multinomial classification, to classify the gesture appearing in an image or sequence of images. The random forest model may be trained and tested using a dataset composed of gesture images containing multi-dimension data points (e.g., multi-dimension training samples). Once trained, the trained multinomial random forest classifier can, in response to input of an image from the interview, predict (classify) the gesture appearing in the image. As mentioned previously, the images of the video stream provided by the interviewee's client show the interviewee. Thus, by inputting an image of the video stream provided by the interviewee's client, the trained multinomial random forest classifier can predict the gesture of the interviewee appearing in the image.

Speech analysis module 524 is operable to identify and segregate the voices in the audio of an interview. In some embodiments, speech analysis module 524 can utilize voice recognition to identify an interviewee's voice in the audio of the interview. Voice recognition is a deep learning technique used to identify, distinguish, and authenticate a particular person's voice. The voice recognition model analyzes countless patterns and elements that distinguish one person's voice from another, such as, for example, voice biometrics, including frequency and flow of pitch, natural accent, excitation mechanism, and behavioral quirks. The voice recognition model may be trained with a training dataset composed of different voices. Once trained, the trained voice recognition model can, in response to input of the audio (e.g., audio signal) of the interview, identify the voice of the interviewee based on the unique bits of data embedded in the audio.

In some embodiments, speech analysis module 524 can utilize speech recognition techniques to identify the words spoken by the interviewee. Speech analysis module 524 can then analyze the words spoken by the interviewee to determine the speech pattern (e.g., the emotions and stress in the voice) of the interviewee. Speech analysis module 524 can store information about the speech pattern of the interviewee within knowledge repository 526, where it can subsequently be retrieved and used.

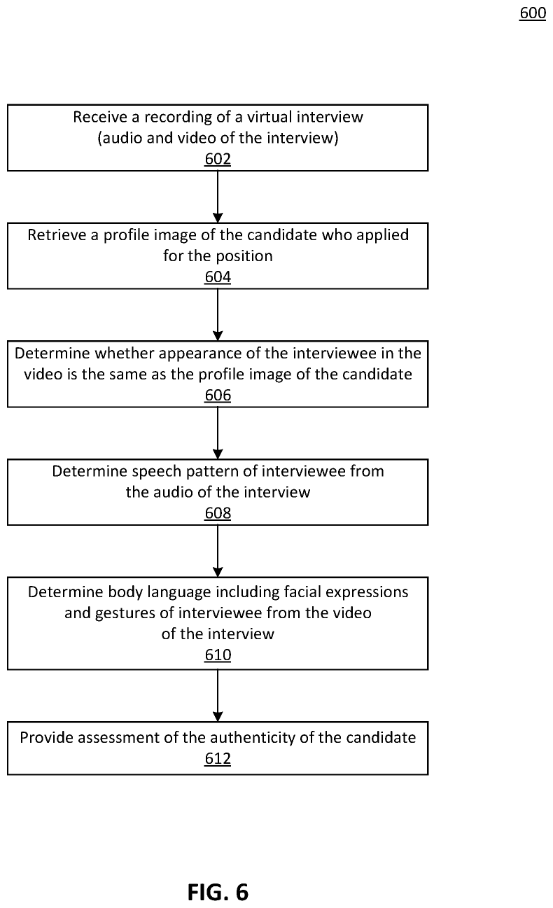

FIG. 6 is a flow diagram of an example process 600 for determining whether a candidate who applied for the position participates in a virtual interview, in accordance with an embodiment of the present disclosure. Illustrative process 600 may be implemented, for example, within system 500 of FIG. 5. In more detail, process 600 may be performed, for example, in whole or in part by authenticity assessment module 518, text analysis module 520, image analysis module 522, and speech analysis module 524, or any combination of these including other components of candidate fraud detection system 408 described with respect to FIGS. 4 and 5.

With reference to process 600 of FIG. 6, at 602, a recording of a virtual interview may be received. For purposes of this discussion, it is assumed that the virtual interview is with a candidate named John who is applying for a position with an organization.

At 604, a profile image of the candidate who applied for the position may be retrieved. A profile image of John may be retrieved from an image repository (e.g., image repository 530) used by the organization to maintain profile images of candidates applying for positions with the organization.

At 606, a determination of whether the appearance of the interviewee in the video is the same as the profile image of the candidate may be made. For example, the appearance of the interviewee in the video of the interview may be compared with the profile image of the candidate to determine whether they are the same. If the appearance of the interviewee in the video is the same as (e.g., matches) the profile image of the candidate, it can be determined that the candidate participated in the interview. Conversely, if the appearance of the interviewee in the video is not the same as (e.g., does not match) the profile image of the candidate, it can be determined that the candidate did not participate in the interview, which is an indication of candidate fraud. In some embodiments, information about the appearance of the interviewee in the video (e.g., an image of the appearance of the interviewee in the video) may be stored within a knowledge repository (e.g., knowledge repository 526) and used to determine whether the same candidate, John, appears in successive interviews, for example.

At 608, the speech pattern of the interviewee may be determined from the audio of the interview. For example, the audio may be analyzed using speech analysis techniques including speech recognition to determine the speech pattern (e.g., tone, modulation, pitch, etc.) of the interviewee. Information about the speech pattern of the interviewee may be stored within a knowledge repository (e.g., knowledge repository 526) and used to determine whether the same candidate, John, appears in successive interviews, for example.

At 610, the body language including facial expressions and gestures of the interviewee may be determined from the video of the interview. For example, the video may be analyzed using image analysis techniques to determine the body language including facial expressions and gestures of interviewee. Information about the body language of the interviewee may be stored within a knowledge repository (e.g., knowledge repository 526) and used to determine whether the same candidate, John, appears in successive interviews, for example.

At 612, an assessment of the authenticity of the candidate may be provided. For example, the assessment may include an indication of whether John participated in the interview as determined at 606. In some embodiments, a report of the assessment of the authenticity of John may be provided to the hiring manager for the position for use in deciding whether to hire John for the position.

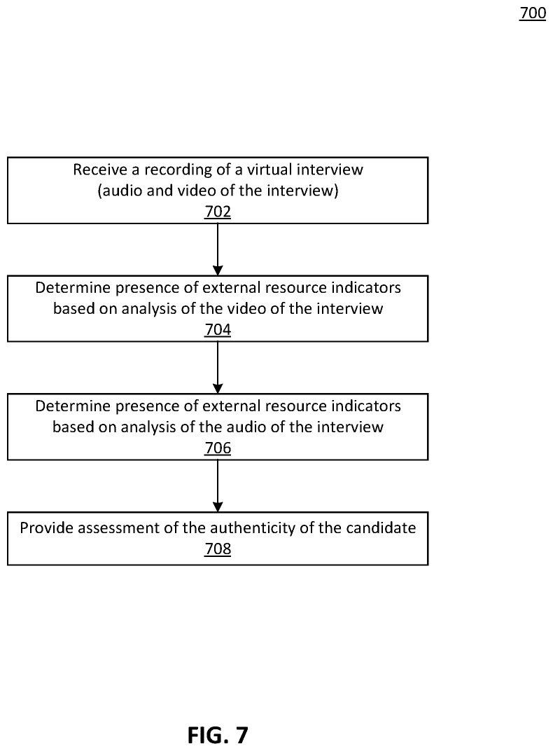

FIG. 7 is a flow diagram of an example process 700 for determining whether an interviewee is participating in a virtual interview independently, in accordance with an embodiment of the present disclosure. Illustrative process 700 may be implemented, for example, within system 500 of FIG. 5. In more detail, process 700 may be performed, for example, in whole or in part by authenticity assessment module 518, text analysis module 520, image analysis module 522, and speech analysis module 524, or any combination of these including other components of candidate fraud detection system 408 described with respect to FIGS. 4 and 5.

With reference to process 700 of FIG. 7, at 702, a recording of a virtual interview may be received. At 704, presence of one or more external resource indicators may be determined based on an analysis of the video of the interview. For example, the video may be analyzed using NLP and image analysis techniques to determine the presence of external resource indicators such as extreme anxiety (e.g., profuse sweating, coughing, or throat clearing by the interviewee), lip synching, mouse exits, mismatches between eye and cursor movements, and the interviewee turning away from the camera, among others. The presence of such external resource indicators in the video may be an indication that the interviewee is possibly using external resources during the interview. In other words, the presence of such external resource indicators may be an indication that the candidate may not be participating in the interview independently, which is an indication of candidate fraud.

At 706, presence of one or more external resource indicators may be determined based on an analysis of the audio of the interview. For example, the audio may be analyzed using NLP and speech analysis techniques to determine the presence of external resource indicators such as extreme anxiety (e.g., coughing, or throat clearing by the interviewee), lip synching, delays in responses to questions, and echoes from speakers, among others. The presence of such external resource indicators in the audio may be an indication that the interviewee is possibly using external resources during the interview. In other words, the presence of such external resource indicators may be an indication that the candidate may not be participating in the interview independently, which is an indication of candidate fraud.

At 708, an assessment of the authenticity of the candidate may be provided. For example, the assessment may include an indication of whether the candidate participated in the interview independently as determined at 704 and 706. In some embodiments, a report of the assessment of the authenticity of the candidate may be provided to a hiring manager for use in evaluating the interviewee.

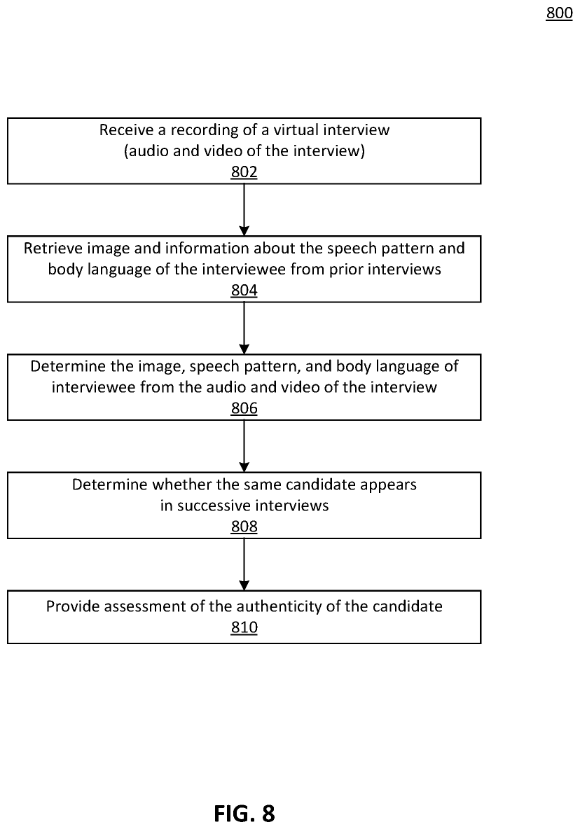

FIG. 8 is a flow diagram of an example process 800 for determining whether the same candidate is interviewing in successive interviews, in accordance with an embodiment of the present disclosure. Illustrative process 800 may be implemented, for example, within system 500 of FIG. 5. In more detail, process 800 may be performed, for example, in whole or in part by authenticity assessment module 518, text analysis module 520, image analysis module 522, and speech analysis module 524, or any combination of these including other components of candidate fraud detection system 408 described with respect to FIGS. 4 and 5.

With reference to process 800 of FIG. 8, at 802, a recording of a virtual interview may be received. For purposes of this discussion, it is assumed that the virtual interview is with a candidate named John who is applying for a position with an organization.

At 804, information about the image, speech pattern, and body language of the interviewee from prior interviews may be retrieved. For example, a profile image of John may be retrieved from an image repository (e.g., image repository 530) and information about John's speech pattern and body language from John's prior interviews may be retrieved a knowledge repository (e.g., knowledge repository 526) used by the organization to maintain such information.

At 806, the image, speech pattern, and body language of the interviewee may be determined from the audio and video of the interview. For example, the audio and video of the interview may be analyzed using speech analysis and image analysis techniques to determine the appearance, speech pattern, and body language of John in the interview (during the current interview).

At 808, a determination of whether the same candidate appears in successive interviews may be made. For example, John's image (e.g., appearance), speech pattern, and body language from John's prior interviews may be compared with John's image (e.g., appearance), speech pattern, and body language in the current interview. If the images, speech patterns, and body language match within a predetermined threshold, it can be determined that the same candidate (e.g., John) appears in successive interviews. Conversely, if the images, speech patterns, and body language do not match within the predetermined threshold, it can be determined that the same candidate (e.g., John) does not appear in successive interviews, which is an indication of candidate fraud. The predetermined threshold may be configured as part of an organizational policy or a user preference.

At 810, an assessment of the authenticity of the candidate may be provided. For example, the assessment may include an indication of whether John participated in successive interviews as determined at 808. In some embodiments, a report of the assessment of the authenticity of John may be provided to the hiring manager for the position for use in deciding whether to hire John for the position.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a recording of a virtual interview, the recording including an audio of the virtual interview and a video of the virtual interview;
retrieving, by the computing device, a profile image of a candidate;
determining, by the computing device, an appearance of an interviewee in the video of the virtual interview;
responsive to a determination that the appearance of the interviewee and profile image do not match, including, by the computing device, an indication that the candidate did not participate in the virtual interview in an assessment of authenticity of the candidate; and
sending, by the computing device, a report of the assessment of the authenticity of the candidate to another computing device.

2. The method of claim 1, further comprising, by the computing device, storing information about the appearance of the interviewee in a knowledge repository.

3. The method of claim 1, further comprising, by the computing device:
determining a speech pattern of the interviewee from the audio of the virtual interview;
and storing information about the speech pattern of the interviewee in a knowledge repository.

4. The method of claim 1, further comprising, by the computing device:
determining a body language of the interviewee from the video of the virtual interview; and
storing information about the body language of the interviewee in a knowledge repository.

5. The method of claim 1, further comprising, by the computing device:
retrieving information about speech pattern and body language of the interviewee from prior interviews;
determining a speech pattern of the interviewee from the audio of the virtual interview;
determining a body language of the interviewee from the video of the virtual interview;
determining whether a same candidate appears in successive interviews based on a comparison of the information about the speech pattern and the body language of the interviewee from the prior interviews and the information about the speech pattern and the body language of the interviewee from the audio and the video of the virtual interview; and
responsive to a determination that the same candidate does not appear in the successive interviews, including an indication that the same candidate does not appear in the successive interviews in the assessment of authenticity of the candidate.

6. The method of claim 1, further comprising, by the computing device:
determining whether the interviewee is participating in the virtual interview independently; and
responsive to a determination that the interviewee is not participating in the virtual interview independently, including an indication that the candidate did not participate in the virtual interview independently in the assessment of authenticity of the candidate.

7. The method of claim 6, wherein the determining whether the interviewee is participating in the virtual interview independently is based on a presence of one or more external resource indicators which indicate possible use of external resources.

8. The method of claim 7, wherein the presence of one or more external resource indicators is based on an analysis of the audio of the virtual interview.

9. The method of claim 7, wherein the presence of one or more external resource indicators is based on an analysis of the video of the virtual interview.

10. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a recording of a virtual interview, the recording including an audio of the virtual interview and a video of the virtual interview;
retrieving a profile image of a candidate;
determining an appearance of an interviewee in the video of the virtual interview;
responsive to a determination that the appearance of the interviewee and profile image do not match, including an indication that the candidate did not participate in the virtual interview in an assessment of authenticity of the candidate; and
sending a report of the assessment of the authenticity of the candidate to a computing device.

11. The system of claim 10, wherein the process further comprises storing information about the appearance of the interviewee in a knowledge repository.

12. The system of claim 10, wherein the process further comprises:
determining a speech pattern of the interviewee from the audio of the virtual interview; and
storing information about the speech pattern of the interviewee in a knowledge repository.

13. The system of claim 10, wherein the process further comprises:
determining a body language of the interviewee from the video of the virtual interview; and
storing information about the body language of the interviewee in a knowledge repository.

14. The system of claim 10, wherein the process further comprises:
retrieving information about speech pattern and body language of the interviewee from prior interviews;
determining a speech pattern of the interviewee from the audio of the virtual interview;
determining a body language of the interviewee from the video of the virtual interview;
determining whether a same candidate appears in successive interviews based on a comparison of the information about the speech pattern and the body language of the interviewee from the prior interviews and the information about the speech pattern and the body language of the interviewee from the audio and the video of the virtual interview; and
responsive to a determination that the same candidate does not appear in the successive interviews, including an indication that the same candidate does not appear in the successive interviews in the assessment of authenticity of the candidate.

15. The system of claim 10, wherein the process further comprises:
determining whether the interviewee is participating in the virtual interview independently; and
responsive to a determination that the interviewee is not participating in the virtual interview independently, including an indication that the candidate did not participate in the virtual interview independently in the assessment of authenticity of the candidate.

16. The system of claim 15, wherein the determining whether the interviewee is participating in the virtual interview independently is based on a presence of one or more external resource indicators which indicate possible use of external resources.

17. The system of claim 16, wherein the presence of one or more external resource indicators is based on an analysis of the audio of the virtual interview.

18. The system of claim 16, wherein the presence of one or more external resource indicators is based on an analysis of the video of the virtual interview.

19. A non-transitory machine-readable medium encoding instructions that when executed by one or more processors cause a process to be carried out, the process including:
receiving a recording of a virtual interview, the recording including an audio of the virtual interview and a video of the virtual interview;
retrieving a profile image of a candidate;
determining an appearance of an interviewee in the video of the virtual interview;
responsive to a determination that the appearance of the interviewee and profile image do not match, including an indication that the candidate did not participate in the virtual interview in an assessment of authenticity of the candidate; and
sending a report of the assessment of the authenticity of the candidate to a computing device.

20. The machine-readable medium of claim 19, wherein the process further comprises:
retrieving information about speech pattern and body language of the interviewee from prior interviews;
determining a speech pattern of the interviewee from the audio of the virtual interview;
determining a body language of the interviewee from the video of the virtual interview;
determining whether a same candidate appears in successive interviews based on a comparison of the information about the speech pattern and the body language of the interviewee from the prior interviews and the information about the speech pattern and the body language of the interviewee from the audio and the video of the virtual interview; and
responsive to a determination that the same candidate does not appear in the successive interviews, including an indication that the same candidate does not appear in the successive interviews in the assessment of authenticity of the candidate.
